(19) United States
(12) Patent Application Publication
(10) Pub. No.: US 2014/0084680 A1
(43) Pub. Date: Mar. 27, 2014

(54) Electrical Power Distribution Module for a Utility Vehicle

(71) Applicant: Kwang Yang Motor Co., Ltd., Kaohsiung (TW)

(72) Inventor: Chien-Ping Tseng, Kaohsiung (TW)

(73) Assignee: KWANG YANG MOTOR CO., LTD., Kaohsiung (TW)

(21) Appl. No.: 14/031,664

(22) Filed: Sep. 19, 2013

(30) Foreign Application Priority Data
Sep. 26, 2012 (TW) 101135338

(51) Int. Cl. B60R 16/03

(52) U.S. Cl. CPC B60R 16/03
USPC 307/10.1

(57) ABSTRACT

An electrical power distribution module is adapted for use with a utility vehicle, which includes a vehicle body frame, and an electric generator driven by an engine to generate electrical power, and includes: a hollow casing secured to the vehicle body frame; a mounting plate connected to the casing for closing a front open end thereof and secured to the vehicle body frame; a cover body connected pivotally to the mounting plate for partially covering an outer surface thereof when in a closed position; and an electrical unit mounted to an assembly of the casing and the mounting plate and operable to generate, based on the electrical power from the electric generator, multiple voltage outputs each having an individual voltage.

### CROSS-REFERENCE TO RELATED APPLICATION

This application claims priority to Taiwanese Application No. 101135338, filed on Sep. 26, 2012, the contents of which are hereby incorporated by reference.

### BACKGROUND OF THE INVENTION

1. Field of the Invention

The invention relates to an electrical power generation system for a vehicle, and more particularly to an electrical power distribution module for a utility vehicle.

2. Description of the Related Art

For a utility vehicle, such as an all terrain vehicle, there is provided an electric generator that is generally driven by a vehicle engine to generate electrical power, which is used to charge a vehicle battery supplying power to the utility vehicle itself. Thus, such utility vehicle cannot provide a specific power output, such as an AC voltage of 110 or 220 volt, for an external electrical appliance. In this case, such utility vehicle may need a portable electric generator serving as a backup power supply to satisfy additional electrical power requirements. However, the portable electric generator is usually is disposed at a location behind the vehicle seats, thereby resulting in inconvenience during use.

Referring to FIG. 1, a portable fuel powered electric generator 200 is shown to include a main frame 201, an electrical power generation unit 202 mounted to the main frame 201 for generating electrical power, a fuel supply container 203 mounted to the main frame 201 and connected to the electrical power generation unit 202, a circuit unit (not shown) coupled to the electrical power generation unit 202, and an operation panel 204 secured to the main frame 201 and provided with a plurality of power sockets, which are coupled to the circuit unit for supplying individual voltage outputs therethrough. However, if the portable fuel powered electric generator 200 is used with a utility vehicle that is often situated in dusty, misty or foggy environments, electrical components thereof may be easily damaged.

### SUMMARY OF THE INVENTION

Therefore, an object of the present invention is to provide an electrical power distribution module for a utility vehicle that can overcome the aforesaid drawbacks of the prior art.

According to the present invention, there is provided an electrical power distribution module for a utility vehicle. The utility vehicle includes a vehicle body frame, an engine mounted to the vehicle body frame, an electric generator mounted to the vehicle body frame and driven by the engine to generate electrical power, and a front protection plate secured to a front portion of the vehicle body frame and provided with a steering wheel and a dashboard thereon. The electrical power distribution module of the invention comprises a hollow casing, a mounting plate, a cover body, and an electrical unit.

The casing is adapted to be secured to the front portion of the vehicle body frame and configured with an accommodating space therein. The casing has a front end opening in spatial communication with the accommodating space.

The mounting plate is connected to the casing for closing the front open end thereof, and is adapted to be secured to the front protection plate of the utility vehicle. The mounting plate has an outer surface.

The cover body is connected pivotally to the mounting plate, and is rotatable relative to the mounting plate between a closed position, where the cover body partially covers the outer surface of the mounting plate, and an open position, where the outer surface of the mounting plate is exposed.

The electrical unit is mounted to an assembly of the casing and the mounting plate, and is adapted to receive the electrical power from the electric generator of the utility vehicle. The electrical unit is operable to generate, based on the electrical power, a plurality of voltage outputs, each of which has an individual voltage.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional portable electric generator;

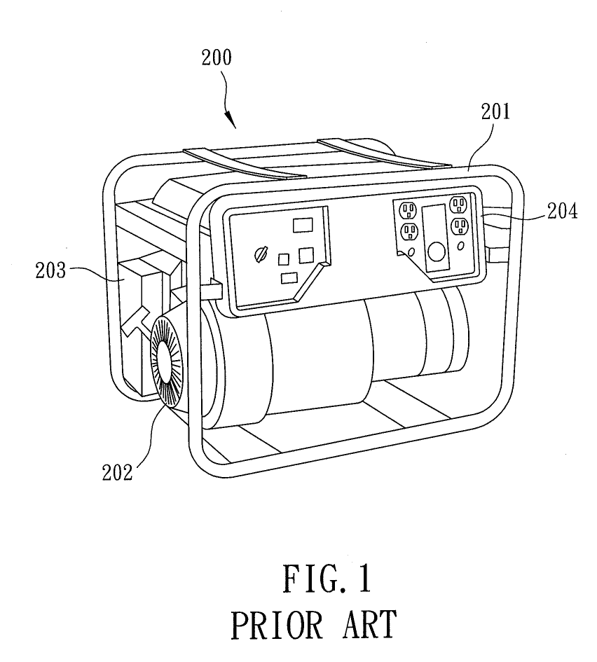

FIG. 2 is a schematic side view showing the preferred embodiment of an electrical power distribution module according to the present invention when assembled to a utility vehicle;

FIG. 3 is a fragmentary schematic partially sectional view showing the preferred embodiment when assembled to the utility vehicle;

FIG. 4 is a fragmentary schematic front view showing the preferred embodiment when assembled to the utility vehicle;

FIG. 5 is a schematic side view showing the preferred embodiment;

FIG. 6 is an exploded perspective view showing the preferred embodiment without an electrical unit;

FIG. 7 is a schematic front view showing the preferred embodiment;

FIG. 8 is a schematic sectional view of the preferred embodiment taken along line VIII-VIII in FIG. 7;

FIG. 9 is a schematic block diagram illustrating the electrical unit of the preferred embodiment; and

FIG. 10 is a schematic front view showing the preferred embodiment without a cover body.

### DETAILED DESCRIPTION OF THE PREFERRED EMBODIMENT

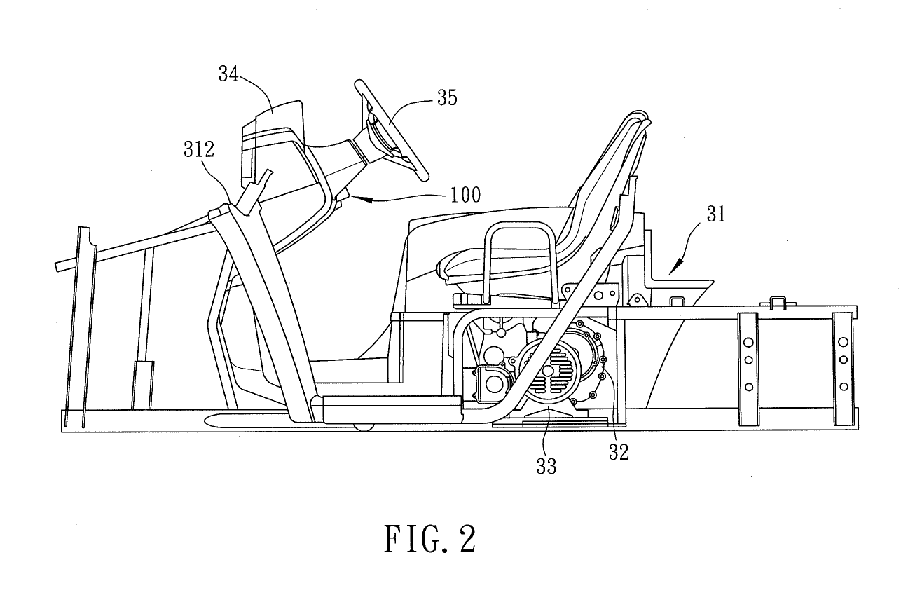

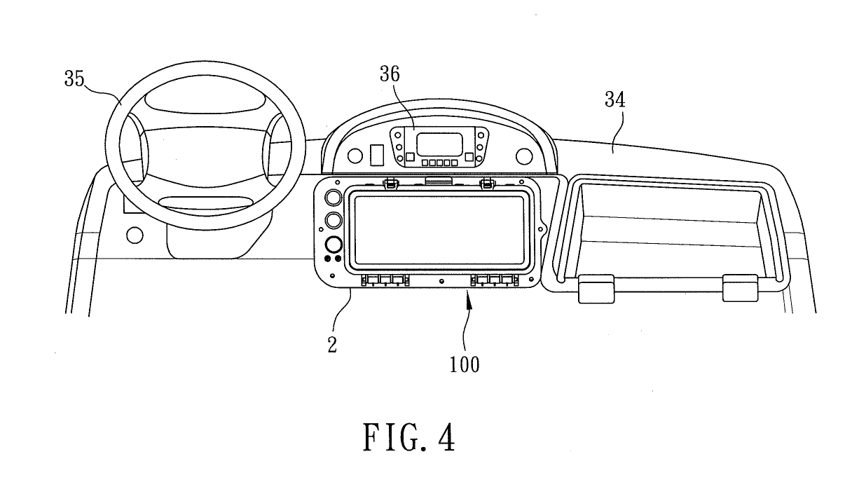

Referring to FIGS. 2 to 4, the preferred embodiment of an electrical power distribution module 100 according to the present invention is shown to use with a utility vehicle, such as an all terrain vehicle. The utility vehicle includes a vehicle body frame 31, an engine 32 mounted to the vehicle body frame 31, an electric generator 33 mounted to the vehicle body frame 31 and driven by the engine 32 to generate electrical power, and a front protection plate 34 secured to a front portion 312 of the vehicle body frame 31 and provided with a steering wheel 35 and a dashboard 36 thereon. In this embodiment, the electrical power distribution module 100 is mounted to the front protection plate 34, is adjacent to the steering wheel 35 and is disposed under the dashboard 36 (see FIG. 4).

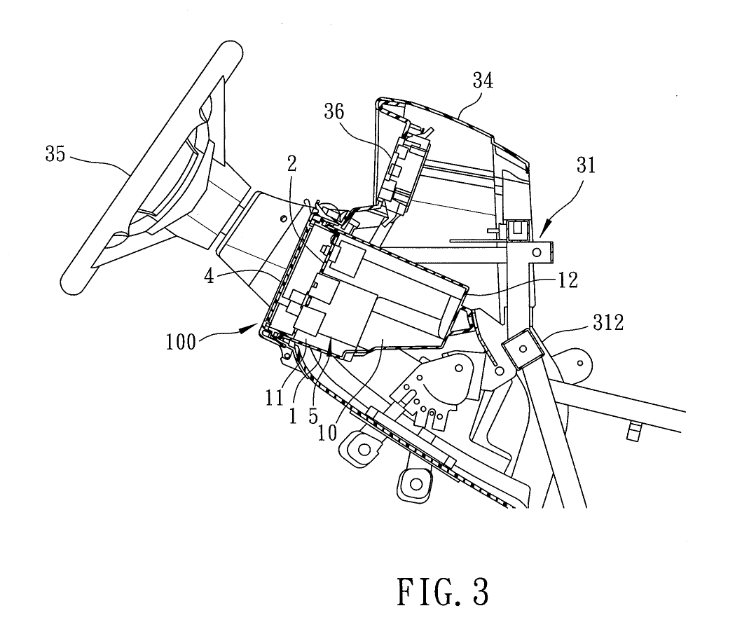

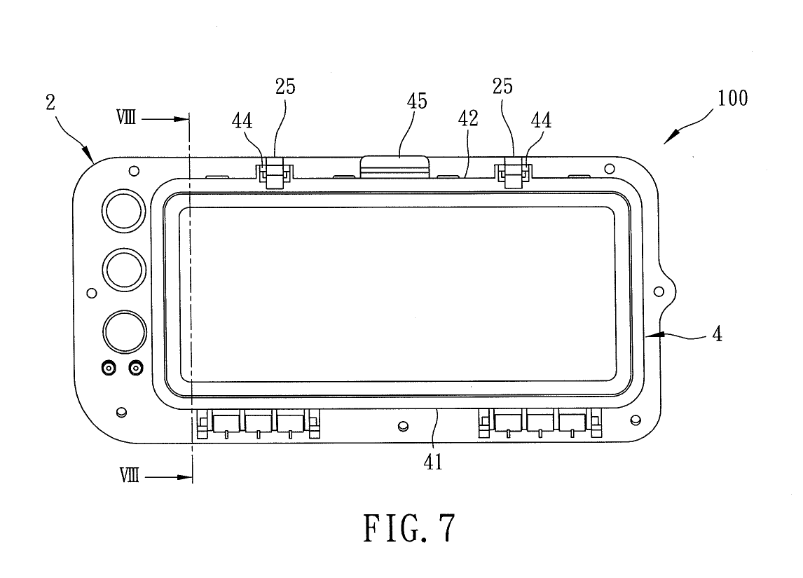

Referring to FIGS. 3, 5, 7 and 8, the electrical power distribution module 100 includes a hollow casing 1, a mounting plate 2, a cover body 4, and an electrical unit 5.

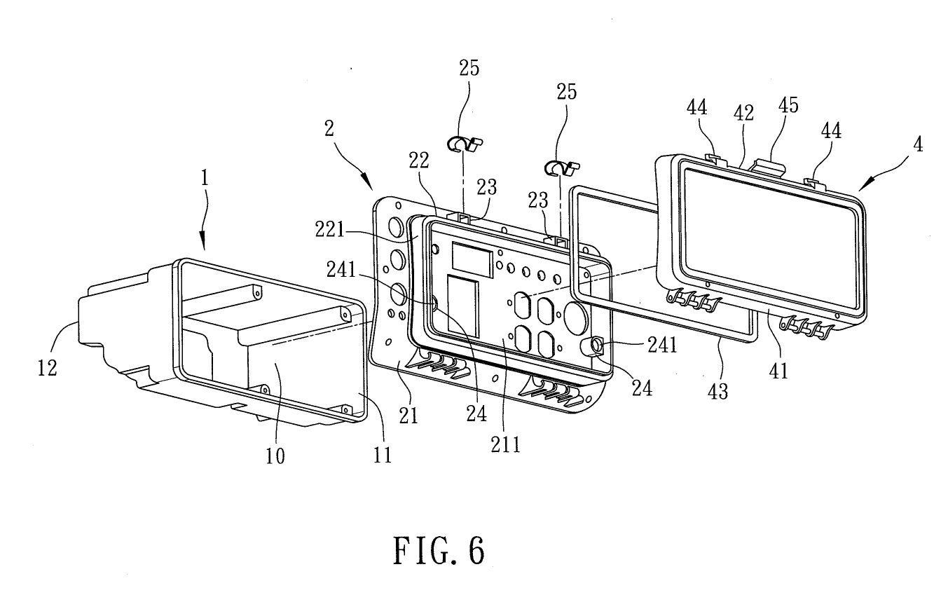

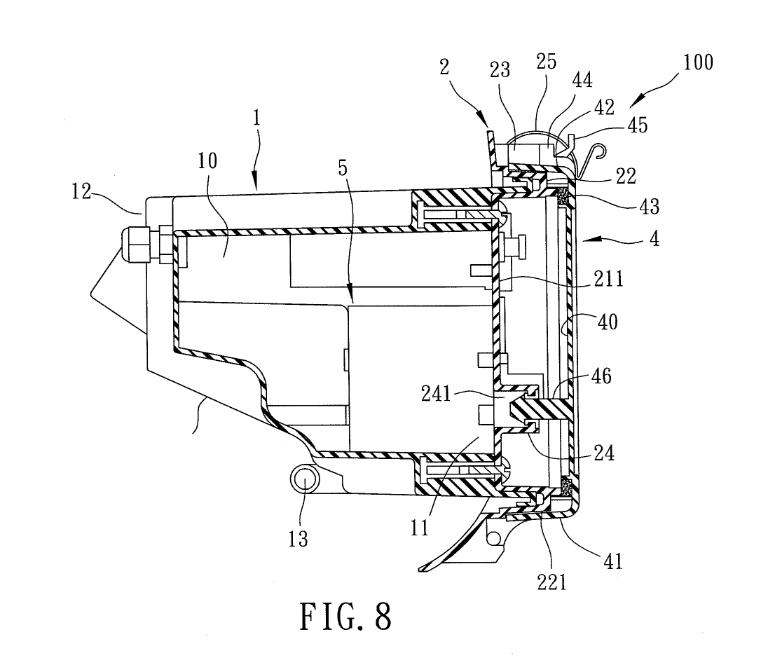

Referring further to FIG. 6, the casing 1 is configured with an accommodating space 10 therein, and has a front end opening 11 in spatial communication with the accommodating space 10 and a rear end 12. As shown in FIG. 3, the rear end 12 of the casing 1 is adapted to be secured to the front portion 312 of the vehicle body frame 31, and the front open end 11 of the casing 1 is adapted to be exposed from the front protection plate 34 of the utility vehicle. The casing 1 further has a rear drain outlet 13 (see FIG. 8) at a bottom thereof. The rear drain outlet 13 is in spatial communication with the accommodating space 10.

The mounting plate 2 is connected to the casing 1 for closing the front end opening 11 thereof, and is adapted to be secured to the front protection plate 34 of the utility vehicle (see FIG. 4). The mounting plate 2 further has an outer surface 21. In this embodiment, referring again to FIG. 6, the mounting plate 2 further has a looped projection 22, two resilient anchoring fasteners 25, two fastener-mounting seats 23, and two protrusions 24 for positioning. The looped projection 22 integrally projects from the outer surface 21 of the mounting plate 2 such that the outer surface 21 of the mounting plate 2 defines a rectangular mounting surface area 211 surrounded by the looped projection 22. The mounting surface area 211 is formed with a plurality of component-mounting holes. The looped projection 22 has an outer circumference 221. The fastener-mounting seats 23 are integrally formed on the outer surface 21 of the mounting plate 2, and are disposed spacedly outside the mounting surface area 211 and adjacent to an upper portion of the looped projection 22. The anchoring fasteners 25 are respectively mounted to the fastener-mounting seats 23. The protrusions 24 integrally protrude from the mounting surface area 211 of the outer surface 21 of the mounting plate 2. Each protrusion 24 is formed with a positioning hole 241.

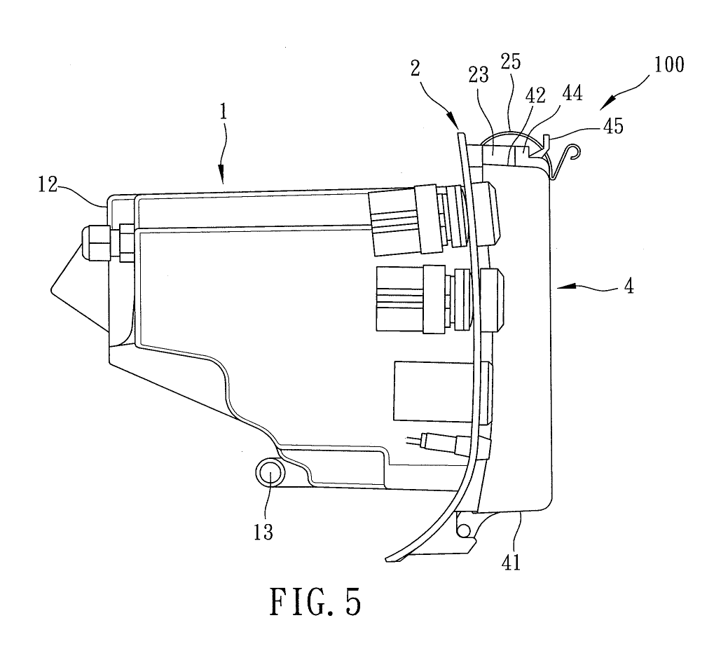

Referring again to FIGS. 5 to 8, the cover body 4 is in the form of a cap, and is rectangular in this embodiment. The cover body 4 has a connecting end 41 connected pivotally to a lower portion of the mounting plate 2, and a free end 42 opposite to the connecting end 41. The cover body 4 is rotatable relative to the mounting plate 2 between a closed position, where the free end 42 of the cover body 4 is adjacent to the mounting plate 2 to partially cover the outer surface 21 of the mounting plate 2, and an open position, where the free end 42 of the cover body 4 is spaced apart from the mounting plate 2 to expose the outer surface 21 of the mounting plate 2. In this embodiment, the cover body 2 further has two extension lugs 44 and an extension handle 45 that project outwardly from the free end 42 of the cover body 4. The extension handle 45 is disposed between the extension lugs 44. When the cover body 4 is in the closed position, each anchoring fastener 25 of the mounting plate 2 releasably anchors a respective extension lug 44 (see FIG. 5). The cover body 4 has an inner surface 40 that abuts against the outer circumference 221 of the looped projection 22 when the cover body 4 is in the closed position, thereby covering the mounting surface area 211 of the outer surface 21 of the mounting plate 2 (see FIG. 8). In addition, the cover body 4 further has a waterproof loop 43, and two positioning plugs 46 (only one is shown in FIG. 8). The waterproof loop 43 is attached to the inner surface 40 of the cover body 4 in a manner that the waterproof loop 43 is sealingly clamped between the inner surface 40 of the cover body 4 and a front edge of the looped projection 22 of the mounting plate 2 when the cover body 4 is in the closed position (see FIG. 8). Each positioning plug 46 integrally projects from the inner surface 40 of the cover body 4, and is inserted into and releasably engages the positioning hole 240 in a respective protrusion 24 of the mounting plate 2 when the cover body 4 is in the closed position, thereby positioning the cover body 4 in the closed position (see FIG. 8).

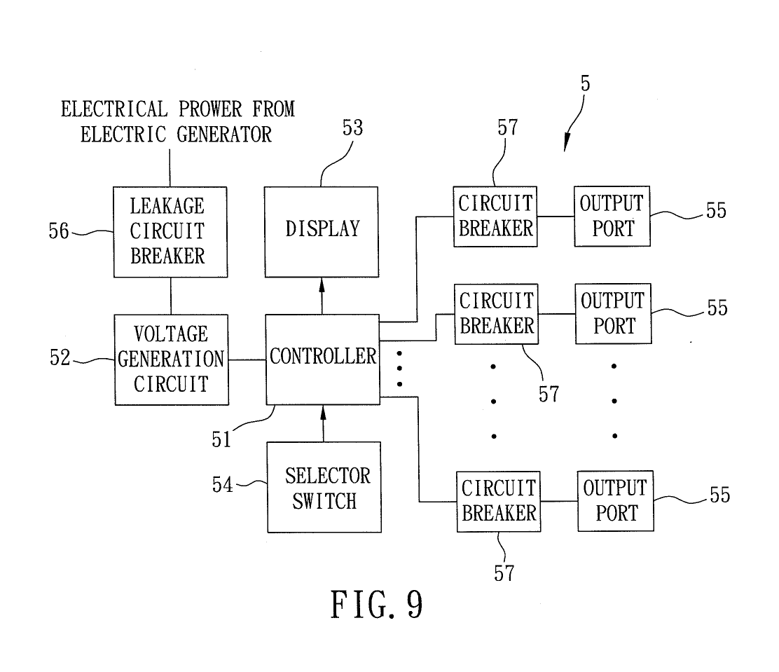

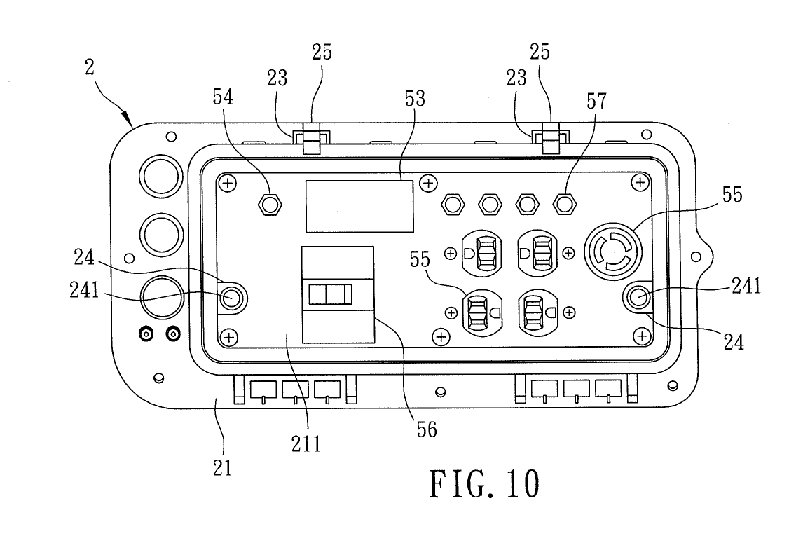

Referring further to FIGS. 8 to 10, the electrical unit 5 is mounted to an assembly of the casing 1 and the mounting plate 2, and is adapted to receive the electrical power from the electric generator 33 of the utility vehicle. The electrical unit 5 is operable to generate, based on the electrical power, a plurality of voltage outputs, each of which has an individual voltage, e.g., AC 110 volt or AC 220 volt. In this embodiment, the electrical unit 5 includes a controller 51, a voltage generation circuit 52, a display 53, a selector switch 54, a plurality of output ports 55, a leakage circuit breaker 56, and a plurality of circuit breakers 57. The controller 51 and the voltage generation circuit 52 are disposed in the accommodating space 10 in the casing 1. The voltage generation circuit 52 is adapted to receive the electrical power from the electric generator of the utility vehicle, and is operable to generate the voltage outputs based on the electrical power in a known manner. The output ports 55 are in the form of power sockets, and are respectively mounted to the mounting surface area 211 of the outer surface 21 of the mounting plate 2 (see FIG. 10). The controller 51 is coupled to the voltage generation circuit 52 for receiving the voltage outputs from the voltage generation circuit 52, and outputs the voltage outputs respectively to the output ports 55. The leakage circuit breaker 56 and the circuit breakers 57, which serve as safety switches, are mounted to the mounting surface area 211 of the outer surface 21 of the mounting plate 2 (see FIG. 10). The leakage circuit breaker 56 is adapted to be coupled between the electric generator 33 of the utility vehicle and the voltage generation circuit 52. Each circuit breaker 57 is coupled between the controller 51 and a respective output port 55. The leakage circuit breaker 56 is used to prevent electric shocks from passing through human bodies and fires from occurring due to leakage. Each circuit breaker 57 is used to cut off an excessive amount of current due to a short circuit and the overflow of current caused by excessive usage of a load (i.e., an electrical appliance). Additionally, the leakage circuit breaker 56 can be manually operated to cut off the electrical power from the electric generator 33 of the utility vehicle. The display 53 is mounted to the mounting surface area 211 of the outer surface 21 of the mounting plate 2, and is coupled to and controlled by the controller 51. The selector switch 54 is mounted to the mounting surface area 211 of the outer surface 21 of the mounting plate 2, and is coupled to the controller 51. The selector switch 54 is operable to generate a selection signal corresponding to the desired one of the voltage outputs, and outputs the selection signal to the controller 51 such that the controller 51 controls the display 53 in response to the selection signal from the selector switch 54 to display the individual voltage of the desired one of the voltage outputs thereon.

To sum up, the electrical power distribution module of the present invention is designed to be mounted to the front protection plate 34 of the utility vehicle, thereby facilitating operation during use. Furthermore, due to the presence of the cover body 4 with the waterproof loop 43, damage to electrical components of the electrical unit 5 resulting from dusty, foggy or misty conditions can be minimized.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electrical power distribution module for a utility vehicle, the utility vehicle including a vehicle body frame, an engine mounted to the vehicle body frame, an electric generator mounted to the vehicle body frame and driven by the engine to generate electrical power, and a front protection plate secured to a front portion of the vehicle body frame and provided with a steering wheel and a dashboard thereon, said electrical power distribution module comprising:
a hollow casing adapted to be secured to the front portion of the vehicle body frame and configured with an accommodating space therein, said casing having a front end opening in spatial communication with said accommodating space;
a mounting plate connected to said casing for closing said front end opening thereof, and adapted to be secured to the front protection plate of the utility vehicle, said mounting plate having an outer surface;
a cover body connected pivotally to said mounting plate and rotatable relative to said mounting plate between a closed position, where said cover body partially covers said outer surface of said mounting plate, and an open position, where said outer surface of said mounting plate is exposed; and
an electrical unit mounted to an assembly of said casing and said mounting plate, and adapted to receive the electrical power from the electric generator of the utility vehicle, said electrical unit being operable to generate, based on the electrical power, a plurality of voltage outputs, each of which has an individual voltage.

2. The electrical power distribution module as claimed in claim 1, wherein said casing further has a rear drain outlet at bottom thereof, said rear drain outlet being in spatial communication with said accommodating space.

3. The electrical power distribution module as claimed in claim 1, wherein:
said cover body has a connecting end connected pivotally to said mounting plate, a free end opposite to said connecting end, and at least one extension lug projecting outwardly from said free end; and
said mounting plate is provided with at least one resilient anchoring fastener for releasably anchoring said extension lug when said cover body is in the closed position.

4. The electrical power distribution module as claimed in claim 3, wherein said cover body further has an extension handle projecting outwardly from said free end of said cover body.

5. The electrical power distribution module as claimed in claim 1, wherein:
said mounting plate has a looped projection integrally projecting from said outer surface thereof such that said outer surface of said mounting plate defines a mounting surface area surrounded by said looped projection, said looped projection having an outer circumference; and
said cover body is in the form of a cap, and has an inner surface that abuts against said outer circumference of said looped projection when said cover body is in the closed position, thereby covering said mounting surface area of said outer surface of said mounting plate.

6. The electrical power distribution module as claimed in claim 5, wherein said cover body further has a waterproof loop attached to said inner surface thereof in a manner that said waterproof loop is sealingly clamped between said inner surface of said cover body and said looped projection of said mounting plate when said cover body is in the closed position.

7. The electrical power distribution module as claimed in claim 5, wherein:
said mounting plate further has a protrusion that protrudes from said mounting surface area of said outer surface thereof and that is formed with a positioning hole; and
said cover body further has a positioning plug that projects from said inner surface thereof and that releasably engages said positioning hole in said protrusion of said mounting plate when said cover body is in the closed position, thereby positioning said cover body in the closed position.

8. The electrical power distribution module as claimed in claim 5, wherein said electrical unit includes:
a voltage generation circuit disposed in said accommodating space and adapted to receive the electrical power from the electric generator of the utility vehicle, said voltage generation circuit being operable to generate the voltage outputs based on the electrical power;
a plurality of output ports mounted to said mounting surface area of said outer surface of said mounting plate;
a controller disposed in said accommodating space, and coupled to said voltage generation circuit and said output ports, said controller receiving the voltage outputs from said voltage generation circuit, and outputting the voltage outputs respectively to said output ports; and
a display mounted to said mounting surface area of said outer surface of said mounting plate, and coupled to and controlled by said controller to display the individual voltage of a desired one of the voltage outputs thereon.

9. The electrical power distribution module as claimed in claim 8, wherein said electrical unit further includes:
a selector switch mounted to said mounting surface area of said outer surface of said mounting plate and coupled to said controller, said selector switch being operable to generate a selection signal corresponding to the desired one of the voltage outputs, and outputting the selection signal to said controller such that said display is controlled by said controller in response to the selection signal from said selector switch to display the individual voltage of the desired one of the voltage outputs thereon;
a leakage circuit breaker mounted to said mounting surface area of said outer surface of said mounting plate, and adapted to be coupled between the electric generator and said voltage generation circuit, said leakage circuit breaker being operable to cut off the electrical power from the electric generator of the utility vehicle; and
a plurality of circuit breakers each mounted to said mounting surface area of said outer surface of said mounting plate and coupled between said controller and a respective one of said output ports.
